(19) United States
(12) Patent Application Publication
(10) Pub. No.: US 2026/0116595 A1
(43) Pub. Date: Apr. 30, 2026

(54) VENTED HOOD FOR PALLETIZED LOADS AND METHOD

(71) Applicant: Allied Packaging Corporation, Phoenix, AZ (US)

(72) Inventors: Darrel BISON, Phoenix, AZ (US); Steven D. SMITH, Phoenix, AZ (US)

(21) Appl. No.: 19/371,962

(22) Filed: Oct. 28, 2025

Related U.S. Application Data
(60) Provisional application No. 63/713,299, filed on Oct. 29, 2024.

(51) Int. Cl. B65B 11/08; B29C 48/00; B29C 48/10; B29C 48/28; B29L 31/00; B65B 11/00; B65B 41/04; B65B 41/10; B65B 51/14; B65B 51/22; B65B 59/00; B65H 18/08; B65H 35/08

(52) U.S. Cl. CPC B65B 11/08; B29C 48/0018; B29C 48/0022; B29C 48/10; B29C 48/28; B65B 41/04; B65B 41/10; B65B 51/14; B65B 51/225; B65B 59/001; B65H 18/08; B65H 35/08; B29C 2793/0045; B29L 2031/712; B65B 2011/002; B65H 2301/5152; B65H 2404/1431

(57) ABSTRACT

Perforated stretch film tube for forming a perforated stretch film hood. A length of flattened stretch film with a thickness of between 0.0025 and 0.0055 or larger is perforated after extrution and wound around a core to form a roll of perforated stretch film tube with a plurality of perforations spaced spaced by at least an inch and having a diameter of less than ½ inch. The roll is loaded into a palletized load hooder machine, opened with gripping arms, sealed and cut at one end to form a pallet hood, and drawn down over the palletized load and released to secure the load to the pallet.

### RELATED APPLICATIONS

This application claims the benefit of U.S. provisional patent application 63/713,299, filed Oct. 29, 2024 to Darrel Bison and Steven D. Smith, titled “VENTED HOOD FOR PALLETIZED LOADS AND METHOD” the entirety of the disclosure of which is hereby incorporated by this reference.

### TECHNICAL FIELD

This document relates to a vented hood for palletized loads, a method of manufacture, and a method of use.

### BACKGROUND

Stretch hooding systems are used in the packaging industry for securing and protecting palletized loads during transportation and storage. They operate by stretching a plastic film over the palletized goods to create a tightly wrapped and sealed unit. This process offers several benefits, including stability, protection from environmental factors such as moisture and dust, and improved handling efficiency.

Certain goods, such as perishable food items, chemicals, and materials requiring controlled storage conditions, need adequate ventilation to prevent spoilage, degradation, or condensation buildup. Conventional stretch hood films are impermeable, restricting airflow and potentially causing excessive heat buildup or moisture retention within the pallet.

### SUMMARY

Aspects of this disclosure relate to a roll of perforated stretch film tube for use in forming a perforated stretch film hood, the roll of perforated stretch film including length of stretch film in a shape of a flattened tube having a tube wall, the length of stretch film coupled to and wound around a spool core, the tube wall having a thickness of between 0.0025 and 0.0055 inches, and a plurality of perforations extending through the tube wall along an entire circumference of the tube wall, the plurality of perforations spaced with a gap of at least 1 inch between each perforation of the plurality of perforations and an adjacent perforation of the plurality of perforations, wherein each of the plurality of perforations has a diameter of less than ½ inch.

Particular embodiments of the disclosure may include one or more of the following features. The gap may be a gap of between 1 inch and 4 inches. Each of the plurality of perforations has a diameter of at least 1/16 inch and the tube wall has a thickness of between 0.0025 and 0.003 inches. The length of stretch film is formed of a polymer. The polymer is polyethylene.

Aspects of the disclosure relate to a method of securing a palletized load with perforated stretch film, the method including providing a roll of perforated stretch film in a shape of a flattened tube wound around a spool core, the perforated stretch film comprising a plurality of perforations each having a diameter of at least 1/16 inch extending through the flattened tube of the perforated stretch film at predetermined spacings throughout the roll, feeding a first end of the perforated stretch film from the roll into a pallet stretch film hood applicator, the pallet stretch film hood applicator configured to pull a length of perforated stretch film tube from the roll of perforated stretch film, open the perforated stretch film tube and position the length of perforated stretch film tube to be received by a plurality of grippers configured receive the length of perforated stretch film hood tube, wherein the plurality of grippers are further configured to stretch the length of perforated stretch film hood tube to match a length and a width of the palletized load, forming a palletized load hood by sealing and severing a first end of the length of perforated stretch film from the roll by at least one of heat-sealing and ultrasonic welding, positioning the perforated stretch film hood above the palletized load, the palletized load having a bottom end positioned on a pallet and a top end, lowering the length of perforated stretch film hood tube from above the palletized load toward the bottom end of the palletized load with the palletized load hood surrounding the palletized load by gripping and stretching the palletized load hood with the plurality of grippers attached to a plurality of movable arms and moving the plurality of movable arms downward from a top of the palletized load to the pallet and releasing respective portions of the palletized load hood as the plurality of moveable arms move downward to cover the palletized load, wherein the first end of the length of perforated stretch film hood tube is configured to be secured at the top end of the palletized load and a second end of the length of perforated stretch film hood tube, distal to the first end, is configured to extend beyond the bottom end of the palletized load, and removing the plurality of grippers from the length of perforated stretch film hood tube, where the perforated stretch film hood tube contracts to encase the palletized load and the plurality of movable arms reset to their original positions.

Particular embodiments of the disclosure may include one or more of the following features. Performing an inspection of the palletized load to ensure that the palletized load is securely encased by the palletized load hood on a top and all sides, wherein the inspection is performed by at least one of an automated sensor system inspection and a visual inspection performed by an operator. Lowering the perforated stretch film extends the second end of the perforated stretch film to a position between the top end of the palletized load and the second end of the palletized load. The roll of perforated stretch film hood tube has a tube wall with a thickness of at least 0.0025 inches. Each of the plurality of perforations of the flattened tube of the perforated stretch film are spaced between 1 inch and 4 inches from each of an adjacent plurality of perforations.

Aspects of the disclosure relate to a method of creating a roll of perforated stretch film on a spool core for use as a perforated stretch film hood, the method including extruding a continuous tube of stretch film in a shape of a flattened tube with a tube wall thickness of between 0.0025 inches and 0.0055 inches, wherein the continuous tube of stretch film is extruded through a blown film extrusion process, passing the continuous tube of stretch film over a perforation roller with the continuous tube of stretch film simultaneously contacting at least 150 radial degrees of the perforation roller as it passes over the perforation roller, wherein the perforation roller contains pins configured to puncture both top and bottom layers of the continuous tube of stretch film and create perforations throughout the continuous tube that have a diameter of at least 1/16 inch to create a continuous perforated tube of stretch film, and winding the continuous perforated tube of stretch film around a spool core after passing the continuous tube of stretch film over the perforation roller.

Particular embodiments of the disclosure may include one or more of the following features. Passing the continuous tube of stretch film over at least a first idler roller prior to passing the continuous tube of stretch film over the perforation roller. Passing the continuous perforated tube of stretch film over at least a second idler roller after passing the continuous tube of stretch film over the perforation roller. Passing the continuous tube of stretch film over a perforation roller with the continuous tube of stretch film simultaneously contacting at least 180 radial degrees of the perforation roller as it passes over the perforation roller. The perforation roller is configured to turn in a direction of movement of the continuous tube of stretch film as the continuous tube of stretch film is passed over perforation roller. The perforation roller further comprising at least one inner ring coupled to at least one outer ring, wherein the at least one outer is configured to hold the plurality of pins, and the at least one inner ring is configured separate the at least outer ring from an adjacent outer ring. The at least one outer ring configured to be detachably coupled to the plurality of pins, wherein the plurality of pins have a diameter of at least 1/16 inch. The at least one inner ring further comprises at least one tightener, wherein the tightener is further configured to secure a pin of the plurality of pins to the at least one outer ring. The perforation roller further comprising a central axle fixedly coupled to at least one inner ring and at least one outer ring. A tapered end of each of the plurality of pins have a length of at least ⅛ inch.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1 is a simplified view of a perforation portion of a film manufacturing system;

FIG. 2 is a cross section of the perforation portion of FIG. 1 taken along section line 2-2;

FIG. 3 is a bottom perspective view of a portion of a perforation roller;

FIG. 4 is a top perspective view of an inner and outer perforation ring;

FIG. 5 is an exploded component view of an inner and outer perforation ring;

FIG. 6 is a front view of an inner perforation ring;

FIG. 7 is a left side view of an inner and outer perforation ring;

FIG. 8 is a rear view of an outer perforation ring;

FIG. 9 is a right side view of an inner and outer perforation ring;

FIG. 10 is a bottom perspective view of the pin;

FIG. 11 is a perspective side view of a pallet stretch film hood applicator;

FIG. 12 is a top perspective view of the pallet stretch film hood applicator;

FIG. 13 is a bottom perspective view of the pallet stretch film hood applicator;

FIG. 14 is a bottom perspective view of the pallet stretch film hood applicator with the sealing clamp closed;

FIG. 15 is a side perspective view of the pallet stretch film hood applicator;

FIG. 16 is a side perspective view of the pallet stretch film hood applicator with the stretch film hood partially applied;

FIG. 17 is a side perspective view of the pallet with the stretch film hood more fully applied; and

FIG. 18 is a side perspective view of a pallet secured with a stretch film hood.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The present disclosure provides a stretch hooding system that incorporates advanced ventilation features into the design and application of the stretch hood film. This film is specifically designed to offer improved airflow, moisture dissipation, and temperature regulation, without compromising the strength or protective capabilities of the packaging. The present disclosure enables the goods to be both securely wrapped and properly ventilated, effectively solving the problems of heat and moisture buildup in conventional stretch hooding systems.

The present disclosure is related to a plastic film for use in a stretch hooding system and creating a perforated stretch film hood that is designed and configured to provide ventilation to the palletized load. Small perforations are included in the film used. Stretch hood film may be made from durable and stretchable polymer material, such as polyethylene. The film is typically extruded into a loop or tube that can be folded or collapsed down to a continuous two-layer sheet, and then rolled up into a roll for storage. This loop can later be unrolled and stretched outward, separating the two sheets at their middles, to insert the palletized load into the film tube. The top end of the film can then be sealed together to enclose the palletized load within the film. With the goal of simplifying the manufacturing process of the film, the film may be perforated as the film is extruded, prior to rolling the film up into a continuous roll. Such a manufacturing process can be carried out by a film manufacturing system.

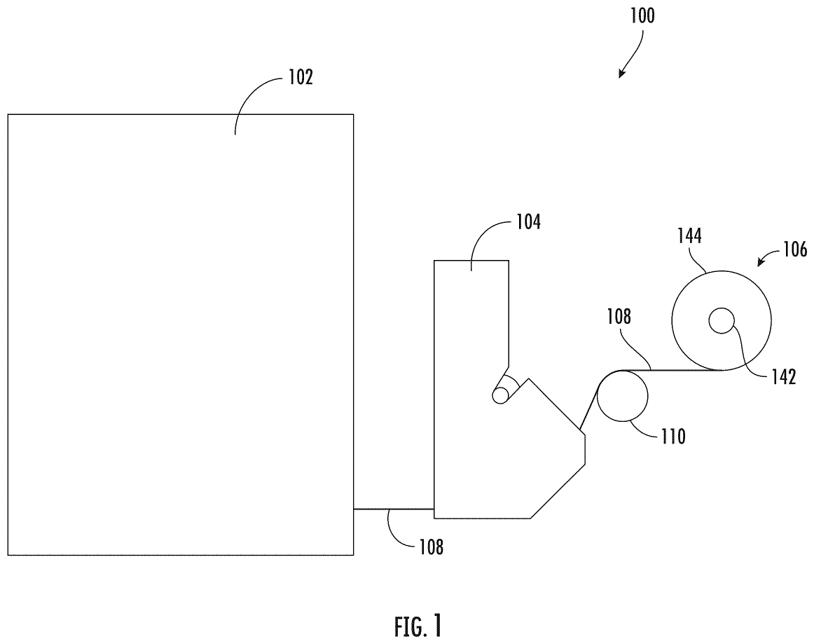

As illustrated in FIG. 1, the film manufacturing system 100 may comprise an extruder 102, a perforation roller assembly 104, and/or a winding system 106. The extruder 102 may be any extrusion machine that is configured to extrude, and form stretch film hood tube 108. Regardless of the specific machine implemented, the extruder 102 is configured to produce stretch film hood tube 108 in a continuous tube that is configured to maintain a compressive force on a load when the load is inserted into the stretch film hood tube 108. Once the stretch film hood tube 108 has been extruded from the extruder 102, cooled and flattened, the perforation roller assembly 104 is configured to form perforations in the flattened stretch film hood tube 108 and the winding system 106 is configured to wind the stretch film hood tube 108 up into a roll 144 of stretch film hood tube 108 to be used to secure a palletized load. Thus, the present disclosure provides a significant advantage over currently known methods of providing ventilation for palletized loads because the perforations are formed in the flattened stretch film hood tube 108 as the stretch film hood tube 108 is extruded, prior to wrapping the stretch film hood tube 108 up into a roll 144. By creating the perforations as the stretch film hood tube 108 is extruded, the present disclosure provides a way to simplify the process and decrease costs.

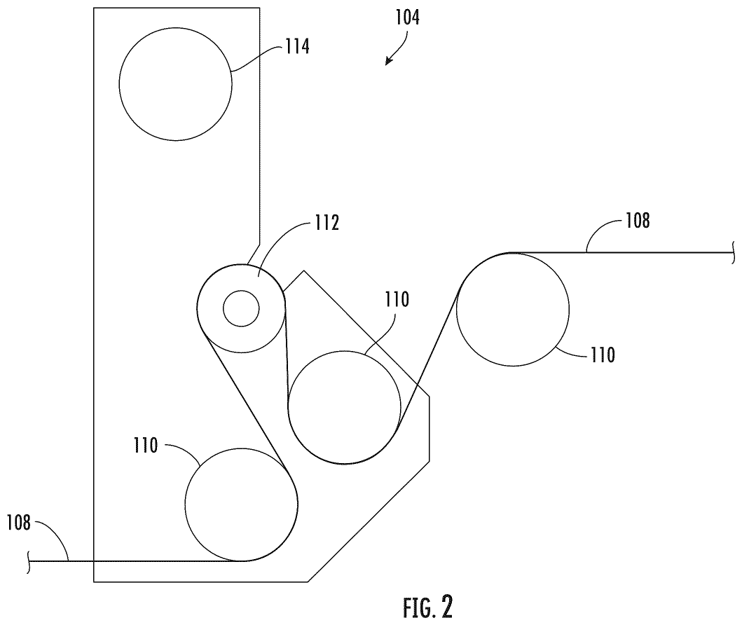

FIG. 2 illustrates a simplified embodiment of the perforation roller assembly of FIG. 1, with a side panel removed to allow for the internals to be seen. The perforation roller assembly 104 may be used to perforate the stretch film hood tube 108. The perforation roller assembly 104 may comprise an idler roller 110, a perforation roller 112, and/or a bypass roller 114. The idler roller 110 is configured to guide the stretch film hood tube 108 through the perforation roller assembly 104 and position the stretch film hood tube 108 for the perforation roller 112 to effectively perforate the stretch film hood tube 108. The idler roller 110 is configured to rotate freely about its axis, thus letting the idler roller 110 rotate with the stretch film hood tube 108 when stretch film hood tube 108 is positioned in contact with the idler roller 110 and the stretch film hood tube 108 is passed over the idler roller 110. In some embodiments, multiple idler rollers 110 may be implemented to guide the stretch film hood tube 108 through the perforation roller assembly 104. For example, as shown in FIG. 2, the perforation roller assembly 104 may comprise a first idler roller 110 positioned before the perforation roller 112 and a second idler roller 110 positioned after the perforation roller 112. The idler rollers 110 may be positioned such that the stretch film hood tube 108 turns by at least 150 degrees when passing over the perforation roller 112, as shown in FIG. 2. In some embodiments, the idler rollers 110 are positioned such that the stretch film hood tube 108 turns by at least 180 degrees. By turning the stretch film hood tube 108 by a greater angle, there is no need to push the stretch film hood tube 108 down onto the perforation roller 112. Instead, stretch film hood tube 108 is pulled against the perforation roller 112 to form the perforations.

The bypass roller 114 is positioned to allow the stretch film hood tube 108 to bypass the perforation roller 112 as the stretch film hood tube 108 passes through the perforation roller assembly 104. This is beneficial because, in embodiments with the bypass roller 114, the perforation roller assembly 104 does not need to be removed if the user desires to manufacture some stretch film hood tube 108 that does not have perforations. Instead, whether perforations are created is determined by whether the stretch film hood tube 108 passes over the perforation roller 112 or the bypass roller 114.

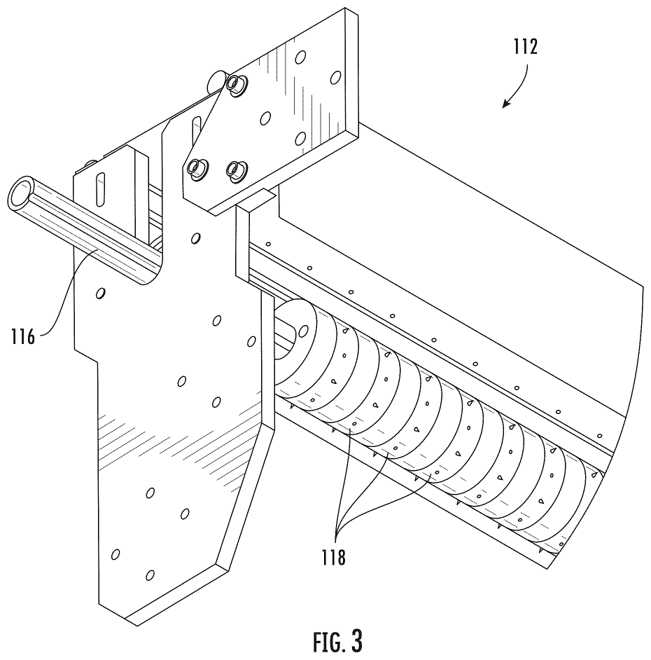

The perforation roller 112 may comprise a center axle 116 and a plurality of perforation rings 118, as illustrated by the embodiment shown in FIG. 3. Each of the perforation rings 118 is positioned on and is axially aligned with the center axle 116. This allows the perforation rings 118 to rotate about the center axle 116 as the stretch film hood tube 108 passes over the perforation roller 112. Each of the perforation rings 118 is configured to perforate the stretch film hood tube 108 when the stretch film hood tube 108 passes over the perforation rings 118.

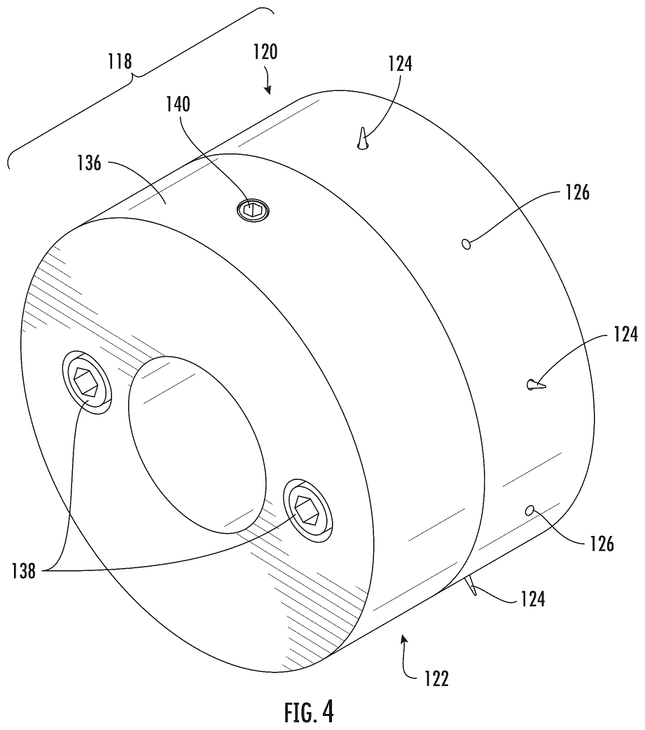

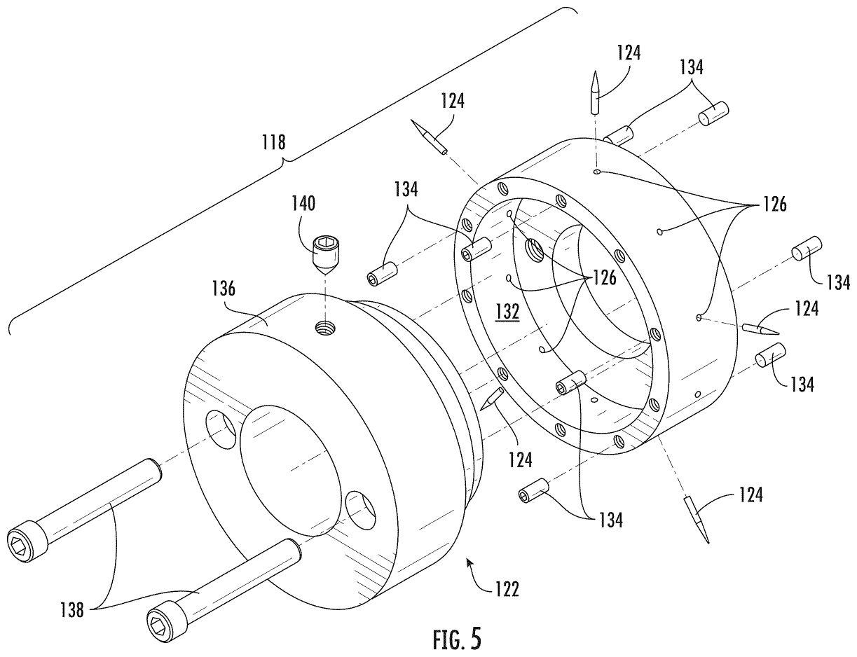

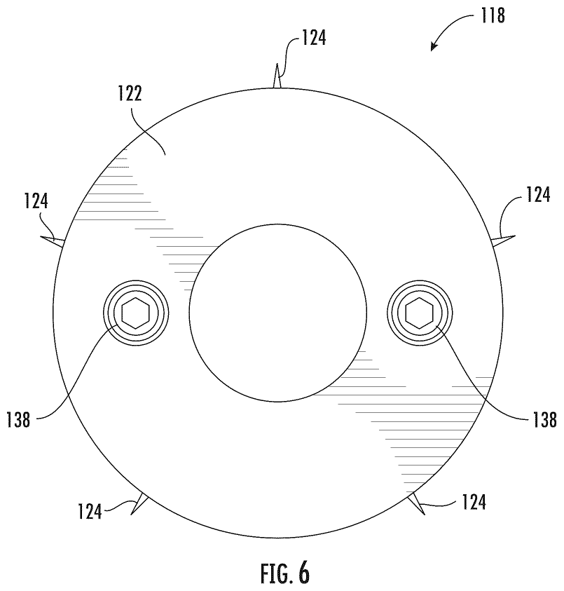

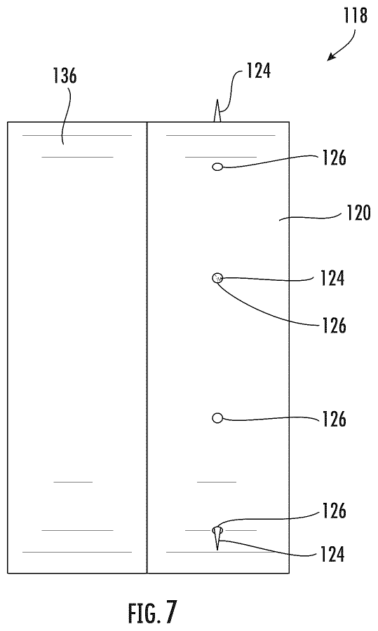

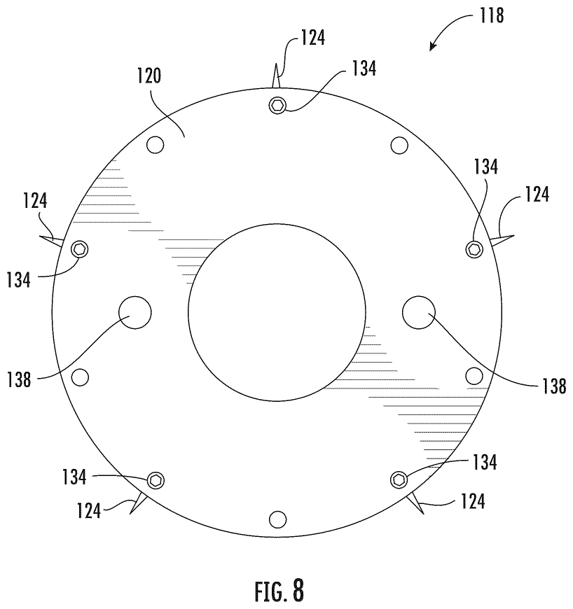

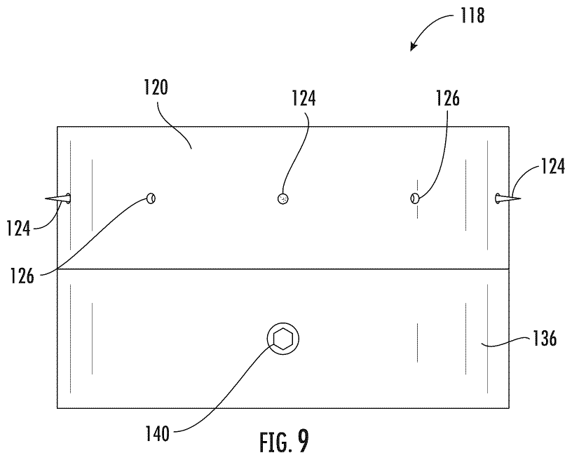

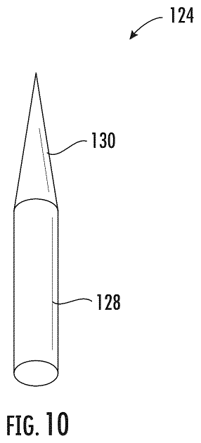

In some embodiments, each of the perforation rings 118 comprises an outer ring 120, an inner ring 122, and a plurality of pins 124, as illustrated in the embodiment shown in FIGS. 4-9. The outer ring 120 may comprise a plurality of pinholes 126 extending through the outer ring 120. The plurality of pinholes 126 may be spaced apart around a circumference of the outer ring 120. The plurality of pins 124 are configured to be positioned in and/or extend through the plurality of pinholes 126. In some embodiments, each of the plurality of pins 124 has a stem 128 and a tapered end 130 opposite the stem 128, as illustrated by the embodiment shown in FIG. 10. The stem 128 may be configured to be positioned within the outer ring 120, while the tapered end 130 may be configured to extend outward from the outer ring 120. In some embodiments, the tapered end 130 of each of the plurality of pins 124 has a length of at least ⅛ inch. However, it will be apparent to one of skill in the art that the length of the tapered end 130 of each of the plurality of pins 124 may be longer or shorter than 0.125 inches. In some embodiments, the tapered end 130 of each of the plurality of pins 124 has a length between 1/16 inch and ¼ inch.

A variety of methods may be implemented to maintain the plurality of pins 124 within the plurality of pinholes 126. In some embodiments, the stem 128 of each of the plurality of pins 124 has a maximum diameter that is larger than a minimum diameter of each of the plurality of pinholes 126. In such embodiments, the plurality of pins 124 may be inserted into the plurality of pinholes 126 from an inside surface 132 of the outer ring 120. This allows the plurality of pins 124 to be inserted into the plurality of pinholes 126 but prevents the plurality of pins 124 from passing completely through the plurality of pinholes 126 because the minimum diameter of each of the plurality of pinholes 126 is smaller than a maximum diameter of each of the plurality of pins 124. In some embodiments, the perforations created by the plurality of pins 124 have a diameter less than or equal to ½ inch. In some embodiments, the diameter of the perforations are less than or equal to ¼ inch. In some embodiments, the maximum diameter of each of the plurality of pins 124 is less than or equal to 0.1 inches. In very particular embodiments, the maximum diameter of each of the plurality of pins 124 is less than or equal to 1/16 inch. This leads to the plurality of pins 124 creating very small perforations or holes in the stretch film hood tube 108 when the stretch film hood tube 108 passes over the perforation roller 112. These smaller holes may later be expanded when the stretch film hood tube 108 is applied to a palletized load, allowing for the increased ventilation discussed above. As will be apparent to one of skill in the art, the plurality of pins 124 may have a maximum diameter that is smaller or larger than 0.1 inches.

In some embodiments, each of the perforation rings 118 may also comprise a plurality of tighteners 134. The plurality of tighteners 134 may be threadedly coupled to the outer ring 120 and may be configured to tighten up against the plurality of pins 124 within the outer ring 120. This allows the plurality of pins 124 to be positioned at the desired depth within the plurality of pinholes 126 and then locked into place with the plurality of tighteners 134 because the plurality of tighteners 134 push against the plurality of pins 124, using friction to prevent further movement of the plurality of pins 124 within the plurality of pinholes 126. In some embodiments, multiple methods of maintaining the plurality of pins 124 within the plurality of pinholes 126 may be implemented.

The inner ring 122 is configured to at least partially insert into the outer ring 120 and sit inside of the outer ring 120. This allows the inner ring 122 to cover the inside surface 132 of the outer ring 120, and therefore help to hold the plurality of pins 124 in an extended position with the tapered end 130 of each of the plurality of pins 124 extending through the plurality of pinholes 126. The inner ring 122 may also comprise a spacer 136 which is configured to separate the outer ring 120 of each perforation ring 118 from the outer ring 120 of adjacent perforation rings 118. The inner ring 122 may be attached to the outer ring 120 with one or more fasteners 138. Each of the perforation rings 118 may also have one or more tighteners 140 that are configured to insert radially into the outer ring 120 or the inner ring 122 toward the center axle 116. The one or more tighteners 140 can thus be used to fix each perforation ring 118 in place on the center axle 116 such that the perforation ring 118 is rotationally fixed with respect to the center axle 116 and also fixed in place along the length of the center axle 116.

The plurality of pins 124 are configured to extend out from the outer ring 120 and are configured to perforate the stretch film hood tube 108 when the stretch film hood tube 108 passes over the perforation rings 118 as described above. As the stretch film hood tube 108 passes over the perforation rings 118, the plurality of pins 124 moves with the stretch film hood tube 108, allowing the plurality of pins 124 to puncture the stretch film hood tube 108 at specific points where the plurality of pins 124 make contact with the stretch film hood tube 108, rather than tearing the stretch film hood tube 108 as would occur if the plurality of pins 124 did not move with the stretch film hood tube 108. The plurality of pins 124 may comprise any number of pins. The perforation rings 118 may be adaptable, allowing the user to select a desired number of pins for the plurality of pins 124. In addition, because the plurality of pins 124 are detachable from the perforation rings 118, pins that break or otherwise need to be replaced or sharpened can be easily detached and replaced with new pins. The plurality of pins 124 may be spaced apart such that the perforations created by the plurality of pins 124 in the stretch film hood tube 108 are spaced between one and four inches apart. Depending on the embodiment, the perforations may be spaced one inch apart, two inches apart, three inches apart, or four inches apart. As will be apparent to a person of skill in the art, any other spacing for the perforations may be implemented, including placing the perforations closer together or further apart.

The present disclosure is also related to a method of perforating the stretch film hood tube 108 for tightly wrapping a load. As noted above, the stretch film hood tube 108 may be extruded as part of this method. In some embodiments, the stretch film hood tube 108 is extruded using a blown film extrusion process. Other extrusion processes may also be implemented. As will be understood by a person of skill in the art, implementing different extrusion processes leads to different material qualities for the stretch film hood tube 108. Different from other stretch film processes used in the industry to create what is conventionally termed as “stretch film” for use in wrapping pallets of goods for shipment by wrapping the film in sequential bands around the stacked pallet numerous times, where the film is typically under 0.5 mil (thousands of an inch), the film used for these processes is typically much thicker on the order of 2.5-5.5 mil or thicker, as is typically used when extruding a plastic hood. The method may comprise extruding stretch film hood tube 108 in a continuous sheet in the form of a tube, and the stretch film hood tube 108 may be configured to maintain a compressive force on a load when the load is inserted inside of the stretch film hood tube 108. There are many manufacturers of stretch film hood plastic on the market with many characteristic thickness options and elasticity options. Those of ordinary skill in the art of pallet wrapping and securing will understand the particular stretch film hood material needs for a particular pallet securing application. For example, stretch hoods manufactured by Cliffe Packaging Ltd (www.cliffepackaging.com/stretch-hood/) and Amcor's Encase Hood® Stretch Hooder film (www.packagingsolutions.amcor.com/en/product/product-item/encase-hood-stretch-hooder-film-14190451), are each examples of acceptable stretch hood plastic materials, the disclosures of each of which are incorporated herein by reference. In particular embodiments, the stretch film hood plastic is formed of a polymer, and in particular embodiments the polymer is polyethylene.

The stretch film hood tube 108 may be passed over the first idler roller 110 and then moved in a first direction toward the perforation roller 112. As the stretch film hood tube 108 passes over the perforation roller 112, the stretch film hood tube 108 may be perforated, and the perforated stretch film hood tube 108 may then be moved in a second direction away from the perforation roller 112. The angle between the first direction and the second direction may be at least 150 degrees. This helps to ensure that the perforation roller 112 effectively perforates the stretch film hood tube 108 before the stretch film hood tube 108 is pulled away from the perforation roller 112. In some embodiments, the angle between the first direction and the second direction is at least 180 degrees. As the stretch film hood tube 108 is passed over the perforation roller 112, the goal is to pass the stretch film hood tube 108 around the perforation roller 112 without adding additional stretch force to the stretch film hood tube 108. This allows the plurality of pins 124 to perforate the stretch film hood tube 108 without stretching the perforations in an undesirable way. The perforated stretch film hood tube 108 may then be passed over the second idler roller 110 and the perforated stretch film hood tube 108 may be wrapped about a core 142 to form a roll 144 of perforated stretch film hood tube 108. This roll 144 of perforated stretch film hood tube 108 can then be transported to individual users that desire to secure loads with the perforated stretch film hood tube 108.

The perforated stretch film hood tube 108 can be used with a stretch hooding system to efficiently and securely package palletized loads. A particular embodiment of the application process for applying perforated stretch film hood tube 108 to a palletized load is detailed below to provide a comprehensive understanding of how the system may function in practice. Other embodiments of this process may include additional steps, may exclude any of the steps listed below, or may accomplish any of the steps detailed below in a different manner.

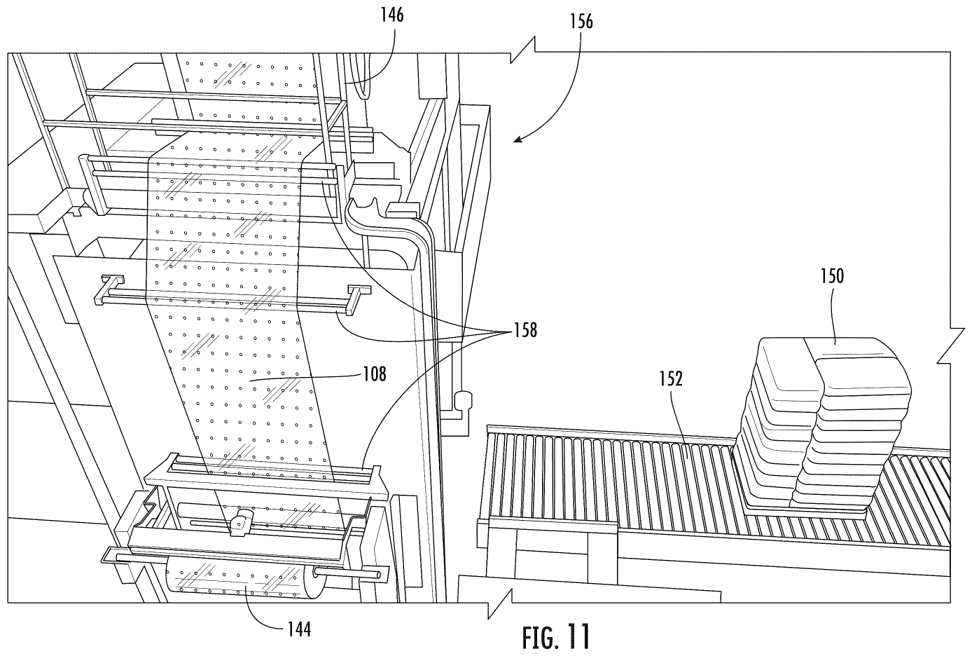

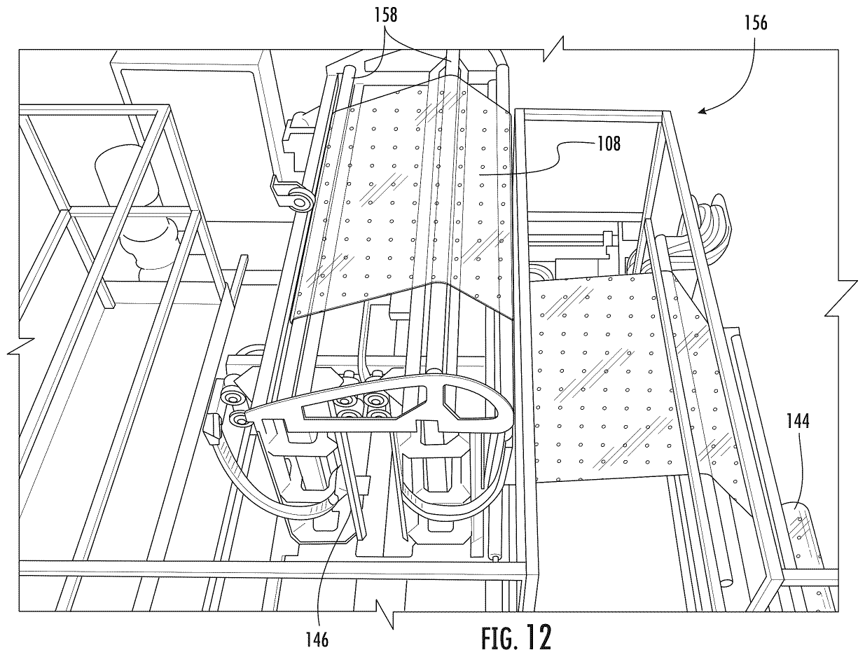

Once the stretch hood film tube 108 is included on a roll 144 of stretch film hood tube, it may be shipped to a remote location for use in a pallet wrapping system for creating and applying a perforated stretch film hood. As illustrated in FIG. 11 and FIG. 12, one or a plurality of palletized loads 150 may be positioned on a conveyor belt system 152, typically located at the entry point of the pallet hooding machine. Each palletized load 150 is typically organized to maintain stability during transportation, and any required corner supports, or protective measures are applied to the edges of the load prior to entry into the pallet hooding machine 156. The pallet hooding system is designed to accommodate various types and sizes of palletized goods, including but not limited to boxes, bags, bottles, or irregularly shaped items. A roll 144 of perforated stretch film hood tube 108 may be loaded on a side of the pallet hooding machine 156 and the end of the perforated stretch film hood tube 108 inserted past at least one idle roller 158 and into the pallet hooding machine 156 through an entrance at the top of the pallet hooding machine 156. The stretch film hood tube 108 end is then fed into an automatic film unwind mechanism 146. The idler roller 158 helps to guide and stretch the perforated stretch film hood tube 108 in a vertical direction, and to adapt to inconsistencies in the film properties as it is pulled through the pallet hooding machine 156. Some embodiments may have more than one idle roller 158 between the roll 144 of perforated stretch film hood tube 108 and the automatic film unwind mechanism 146 when more than one idle roller 158 is needed to properly stretch and guide the perforated stretch film hood tube 108. The automatic film unwind mechanism 146, as well as a portion of the multiple idle rollers 158 of this embodiment, are more clearly illustrated in FIG. 12. The automatic film unwind mechanism 146 automatically pulls a predetermined length of perforated stretch film hood tube 108 from the roll 144 depending upon the height of the pallet load to be hooded. The amount of stretch film hood tube 108 the automatic film unwind mechanism 146 pulls from the roll 144 is enough to form the hood when the stretch film hood tube 108 is sealed and cut, and to cover the palletized load 150 when the stretch film hood is pulled down over the palletized load 150. In some embodiments, the amount of perforated stretch film hood tube 108 pulled from roll 144 is determined by a user or a plurality of sensor coupled to the pallet hooding machine 156.

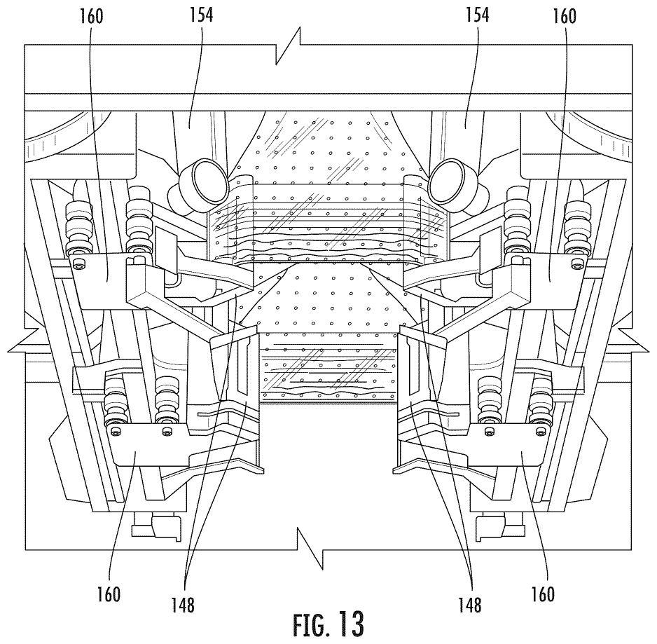

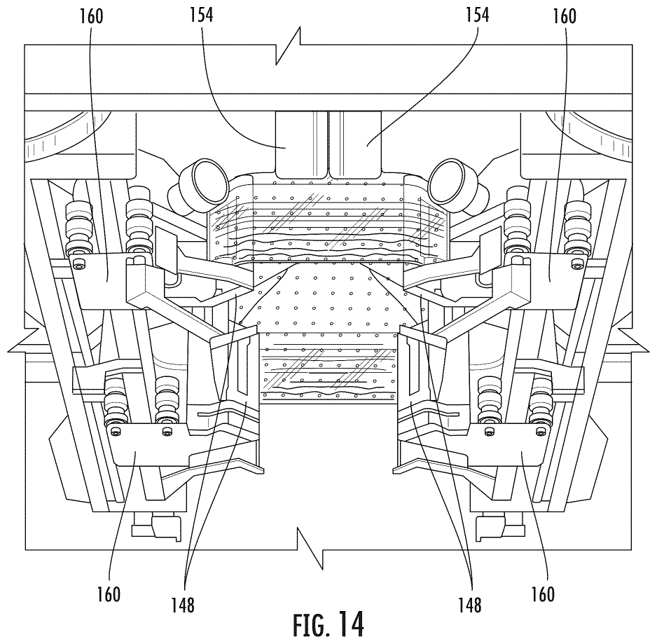

As illustrated in FIG. 13 and FIG. 14, the automatic film unwind mechanism 146 feeds the perforated stretch film hood tube 108 to a plurality of grippers 148 that opens the perforated stretch film hood tube 108 and stretches the opening wide enough to fit over the palletized load 150. If the stretch film hood tube is not previously sealed and cut into a stretch film hood, at least one pair of sealing arms 154 may be included between the plurality of grippers 148 and automatic film unwind mechanism 146, for example as shown in FIGS. 13-14. The pair of sealing arms 154 are configured to seal and cut one end of the perforated stretch film hood tube 108 to form a stretch film hood once the plurality if grippers 148 have received the preselected length of perforated stretch film hood tube 108. The pair of sealing arms 154 may utilize various methods cutting and sealing the perforated stretch film hood tube 108, such as heat sealing, ultrasonic welding, or any other methods known in the art. Some embodiments may not utilize the sealing function of the at least one pair of sealing arms 154, utilizing the sealing arms solely to cut the perforated stretch film hood tube 108 and leaving the top end of the hood unsealed. Once the perforated stretch film hood tube 108 is cut and sealed, the portion gathered on the plurality of grippers 148 is stretched to a length and width to fit the palletized load 150, determined by the length and width of the palletized load 150 itself. The plurality of grippers 148 are moved by a plurality of movable arms 160, with each of the plurality of grippers 148 coupled to at least one movable arm 160.

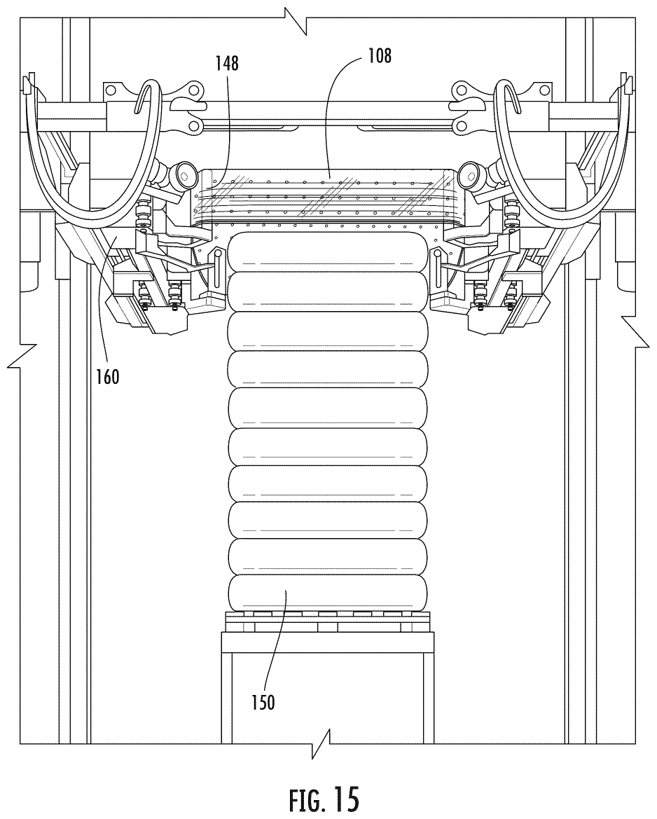

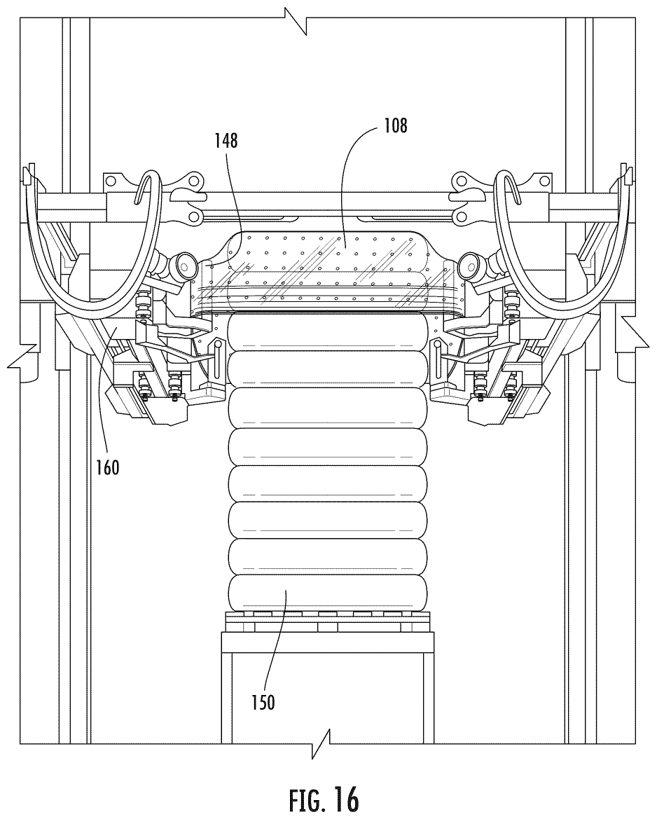

As illustrated in FIGS. 15-17, the plurality of movable arm 160 are configured to position the perforated stretch film hood tube 108 and plurality of grippers 148 above the palletized load 150 as it is moved into place by a conveyor belt system 152 that is coupled to the base of the pallet hooding machine 156. Once the perforated stretch film hood tube 108 is positioned above the palletized load 150, the plurality of movable arms 160 descends and sheaths the palletized load 150 in the perforated stretch film hood tube 108. Once the palletized load 150 is sheathed, the plurality of grippers 148 are removed from the perforated stretch film hood tube 108 and the perforated stretch film hood tube 108, due to its elastic properties, contracts to create a secure fit around the portion of the palletized load 150 that is covered by the perforated stretch film hood tube 108, creating tension that holds the palletized load 150 firmly in place, adding stability to the palletized load 150 even during rough handling or transportation. The pallet hooding machine 156 may be configured to only partially-sheath the pallet 150. The amount of the palletized load 150 that is sheathed is determined by the user and may sheath the pallet to the base of the palletized load 150. The perforated stretch film hood tube 108 has a thickness of 0.0025-0.0055 inches (2.5-5.5 MIL) or higher, allowing the perforation to not significantly deform during the process of sheathing the palletized load 150 in the perforated stretch film hood tube 108. In some embodiments, the tube wall has a thickness of 0.0025-0.003 inches

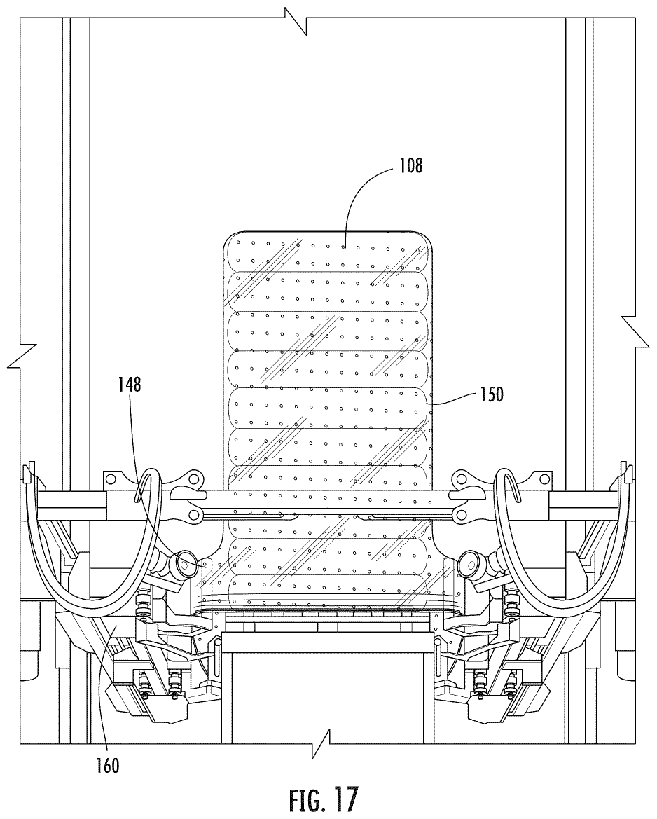

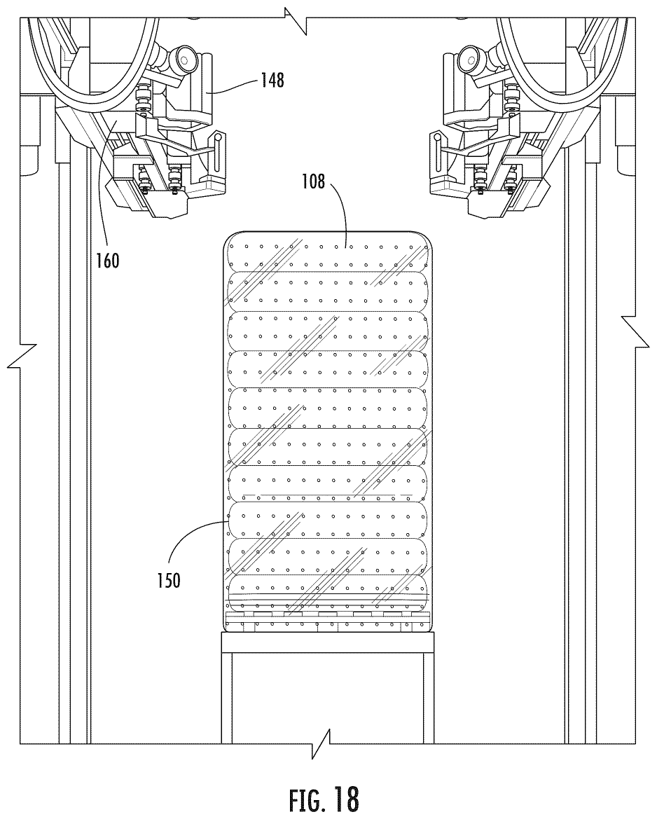

After the perforated stretch film hood tube 108 is applied, as illustrated in FIGS. 17-18, a final inspection is conducted to ensure the perforated stretch film hood tube 108 is properly secured and the palletized load 150 is stable. This inspection may be automated through sensors or visually checked by an operator. Once the palletized load 150 passes inspection, it is ready for transport and storage. The conveyor system moves the palletized load 150 to the next stage in the logistics process, whether it is for storage in a warehouse or loading onto transportation vehicles, and the next load to be secured is moved into position.

Many additional implementations are possible. Further implementations are within the CLAIMS.

It will be understood that implementations of the perforated stretch film and method of securing a palletized load with perforated stretch film include but are not limited to the specific components disclosed herein, as virtually any components consistent with the intended operation of various perforated stretch films and methods of securing a palletized load with perforated stretch film may be utilized. Accordingly, for example, it should be understood that, while the drawings and accompanying text show and describe particular perforated stretch film and method of securing a palletized load with perforated stretch film implementations, any such implementation may comprise any shape, size, style, type, model, version, class, grade, measurement, concentration, material, weight, quantity, and/or the like consistent with the intended operation of perforated stretch films and methods of securing a palletized load with perforated stretch film.

The concepts disclosed herein are not limited to the specific perforated stretch film and method of securing a palletized load with perforated stretch film shown herein. For example, it is specifically contemplated that the components included in particular perforated stretch films and methods of securing a palletized load with perforated stretch film may be formed of any of many different types of materials or combinations that can readily be formed into shaped objects and that are consistent with the intended operation of the perforated stretch film and method of securing a palletized load with perforated stretch film. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, perforated stretch films and methods of securing a palletized load with perforated stretch film may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular perforated stretch film and method of securing a palletized load with perforated stretch film implementations, it should be readily apparent that a number of modifications may be made without departing from the spirit thereof and that these implementations may be applied to other implementations disclosed or undisclosed. The presently disclosed perforated stretch films and methods of securing a palletized load with perforated stretch film are, therefore, to be considered in all respects as illustrative and not restrictive.

We claim:

1. A roll of perforated stretch film tube for use in forming a perforated stretch film hood, the roll of perforated stretch film comprising:
a length of stretch film in a shape of a flattened tube having a tube wall, the length of stretch film coupled to and wound around a spool core, the tube wall having a thickness of between 0.0025 and 0.0055 inches; and
a plurality of perforations extending through the tube wall along an entire circumference of the tube wall, the plurality of perforations spaced with a gap of at least 1 inch between each perforation of the plurality of perforations and an adjacent perforation of the plurality of perforations;
wherein each of the plurality of perforations has a diameter of less than ½ inch.

2. The roll of perforated stretch film tube of claim 1, wherein the gap is a gap of between 1 inch and 4 inches.

3. The roll of perforated stretch film tube of claim 1, wherein each of the plurality of perforations has a diameter of at least 1/16 inch and the tube wall has a thickness of between 0.0025 and 0.003 inches.

4. The roll of perforated stretch film tube of claim 1, wherein the length of stretch film is formed of a polymer.

5. The roll of perforated stretch film tube of claim 4, wherein the polymer is polyethylene.

6. A method of securing a palletized load with perforated stretch film, the method comprising:
providing a roll of perforated stretch film in a shape of a flattened tube wound around a spool core, the perforated stretch film comprising a plurality of perforations each having a diameter of at least 1/16 inch extending through the flattened tube of the perforated stretch film at predetermined spacings throughout the roll;
feeding a first end of the perforated stretch film from the roll into a pallet stretch film hood applicator, the pallet stretch film hood applicator configured to pull a length of perforated stretch film tube from the roll of perforated stretch film, open the perforated stretch film tube and position the length of perforated stretch film tube to be received by a plurality of grippers configured receive the length of perforated stretch film hood tube, wherein the plurality of grippers are further configured to stretch the length of perforated stretch film hood tube to match a length and a width of the palletized load;
forming a palletized load hood by sealing and severing a first end of the length of perforated stretch film from the roll by at least one of heat-sealing and ultrasonic welding;
positioning the perforated stretch film hood above the palletized load, the palletized load having a bottom end positioned on a pallet and a top end;
lowering the length of perforated stretch film hood tube from above the palletized load toward the bottom end of the palletized load with the palletized load hood surrounding the palletized load by gripping and stretching the palletized load hood with the plurality of grippers attached to a plurality of movable arms and moving the plurality of movable arms downward from a top of the palletized load to the pallet and releasing respective portions of the palletized load hood as the plurality of moveable arms move downward to cover the palletized load, wherein the first end of the length of perforated stretch film hood tube is configured to be secured at the top end of the palletized load and a second end of the length of perforated stretch film hood tube, distal to the first end, is configured to extend beyond the bottom end of the palletized load; and
removing the plurality of grippers from the length of perforated stretch film hood tube, where the perforated stretch film hood tube contracts to encase the palletized load and the plurality of movable arms reset to their original positions.

7. The method of securing a palletized load of claim 6, the method further comprising performing an inspection of the palletized load to ensure that the palletized load is securely encased by the palletized load hood on a top and all sides, wherein the inspection is performed by at least one of an automated sensor system inspection and a visual inspection performed by an operator.

8. The method of securing a palletized load of claim 6, wherein lowering the perforated stretch film extends the second end of the perforated stretch film to a position between the top end of the palletized load and the second end of the palletized load.

9. The method of securing a palletized load of claim 6, wherein the roll of perforated stretch film hood tube has a tube wall with a thickness of at least 0.0025 inches.

10. The method of securing a palletized load of claim 6, wherein each of the plurality of perforations of the flattened tube of the perforated stretch film are spaced between 1 inch and 4 inches from each of an adjacent plurality of perforations.

11. A method of creating a roll of perforated stretch film on a spool core for use as a perforated stretch film hood, the method comprising:
extruding a continuous tube of stretch film in a shape of a flattened tube with a tube wall thickness of between 0.0025 inches and 0.0055 inches, wherein the continuous tube of stretch film is extruded through a blown film extrusion process;
passing the continuous tube of stretch film over a perforation roller with the continuous tube of stretch film simultaneously contacting at least 150 radial degrees of the perforation roller as it passes over the perforation roller, wherein the perforation roller contains pins configured to puncture both top and bottom layers of the continuous tube of stretch film and create perforations throughout the continuous tube that have a diameter of at least 1/16 inch to create a continuous perforated tube of stretch film; and
winding the continuous perforated tube of stretch film around a spool core after passing the continuous tube of stretch film over the perforation roller.

12. The method of creating a roll of perforated stretch film of claim 11, further comprising passing the continuous tube of stretch film over at least a first idler roller prior to passing the continuous tube of stretch film over the perforation roller.

13. The method of creating a roll of perforated stretch film of claim 12, further comprising passing the continuous perforated tube of stretch film over at least a second idler roller after passing the continuous tube of stretch film over the perforation roller.

14. The method of creating a roll of perforated stretch film of claim 11, further comprising passing the continuous tube of stretch film over a perforation roller with the continuous tube of stretch film simultaneously contacting at least 180 radial degrees of the perforation roller as it passes over the perforation roller.

15. The method of creating a roll of perforated stretch film of claim 11, wherein the perforation roller is configured to turn in a direction of movement of the continuous tube of stretch film as the continuous tube of stretch film is passed over perforation roller.

16. The method of creating a roll of perforated stretch film of claim 11, the perforation roller further comprising at least one inner ring coupled to at least one outer ring, wherein the at least one outer is configured to hold the plurality of pins, and the at least one inner ring is configured separate the at least outer ring from an adjacent outer ring.

17. The method of creating a roll of perforated stretch film of claim 15, the at least one outer ring configured to be detachably coupled to the plurality of pins, wherein the plurality of pins have a diameter of at least 1/16 inch.

18. The method of creating a roll of perforated stretch film of claim 16, wherein the at least one inner ring further comprises at least one tightener, wherein the tightener is further configured to secure a pin of the plurality of pins to the at least one outer ring.

19. The method of creating a roll of perforated stretch film of claim 11, the perforation roller further comprising a central axle fixedly coupled to at least one inner ring and at least one outer ring.

20. The method of creating a roll of perforated stretch film of claim 11, wherein a tapered end of each of the plurality of pins have a length of at least ⅛ inch.
